(19) United States
(12) Patent Application Publication
(10) Pub. No.: US 2007/0107828 A1
(43) Pub. Date: May 17, 2007

(54) Tape pressure roller with patterned surface for tape applicator

(75) Inventors: Joel F. Barker, Townville, SC (US); Christopher R. Scoville, Carnesville, GA (US); Brian M. Peek, Cornelia, GA (US)

Correspondence Address: Huber Engineered Woods L.L.C.;c/o J.M. Huber Corporation, Law Department, 333 Thornall Street, Edison, NJ, 08837-2220, US

(73) Assignee: Huber Engineered Woods L.L.C., Charlotte, NC (US)

(21) Appl. No.: 11/274,192

(22) Filed: Nov. 16, 2005

(51) Int. Cl. E04F 13/00; B44C 7/00; B32B 37/00

(52) U.S. Cl. 156/71; 156/577; 156/579; 156/581; 156/249

(57) ABSTRACT

A patterned pressure roller for tape applicators useful for reducing the pressure required to seat pressure-sensitive tape and methods of use thereof.

### FIELD OF THE INVENTION

This invention relates to tape applicator pressure rollers for applying adhesive tape material and methods of use thereof.

### BACKGROUND OF THE INVENTION

The roof and wall structures of residential or commercial buildings are typically constructed by attaching several structural panels to the rafters of an underlying supporting structural frame. The panels are most often placed in a quilt-like pattern with the edge of each panel contacting the edges of adjacent panels so as to form a substantially continuous flat surface atop and surrounding the structural frame. In the case of roofs, a water barrier layer, such as felt paper, is then applied over the panels before the installation of shingles, tiles, shakes, or other outer roofing materials. The use of felt paper has many drawbacks including, but not limited to, the extensive labor needed to apply it and its susceptibility to wind damage before the installation of an outer layer of shingles or other roofing material thereon.

Felt paper, typically supplied in roll form, has been applied manually, or using devices such as a so-called roofing machine (e.g., see U.S. Pat. No. 907,731), which usually includes a wheeled frame which is pulled or pushed across the roof by an operator. The frame often carries a roll of felt paper on a storage roller, and a pressure roller rolls along the roof surface and presses the felt web dispensed from the storage roller against the previously laid down roofing layer. Also, a roof surface often is irregular or uneven. Pressure rollers were suggested that should press against felt paper with pressure along the width of the pressure roller while conforming the layer of felt paper to an uneven contour of a roof surface being covered. Roofing machines having frame, support roll, handle, and a deformable pressure roller configuration also have been proposed (e.g., see U.S. Pat. No. 4,460,433). These prior roofing machines are not designed to be handheld during their operation. The need to haul a relatively bulky machine on and off roofs is very inconvenient. Also, bulky roofing machines may not be convenient for use at edges of roofs and/or around upright obstacles commonly encountered on a roof such as chimneys and vent pipes. In addition, roofs having steeper pitch may not be conducive for operation of a roofing machine thereon needing an operator to maintain a generally upright stance. Also, the prior roofing machines generally can not also be used for other significant construction site tasks such as wall construction, and so forth.

Water-resistant seam tape has been applied to seams between adjoining roofing or wall panels by bare hand as part of a water-proofing scheme. The process is slow, cumbersome and laborious. A seam tape applicator for applying a seam tape to an edge of a membrane sheet has been described including a frame which can be pushed via handle by an operator without bending over (e.g., see U.S. Pat. Appln. Publ. No. 2004/0129387 A1). The applicator applies a seam tape to a surface in such a way that an upper release liner is not separated from the seam tape until after the tape has already been applied to the lower edge of a seam.

For wall installations in building construction, an extra step must typically be added to the installation process to prevent liquid moisture and air from passing through the wall. Specifically, constructing a wall with a weather barrier requires not only that panels be attached to framing members, but also a house wrap is unrolled and spread over the walls. The house wrap is attached to the sheathing panels with staples or button cap nails and fenestration openings for windows or doors must be cut out of the wrap and the flaps from these openings folded back and stapled down. The house wrap is often difficult to install because it typically is in wide, e.g., nine feet wide, rolls, which can be difficult to maneuver by workers on scaffolding or in windy conditions. To help prevent mold growth, a drainage plane is optionally applied. The use of the moisture barrier wrap, or a drainage plane increases cost due to increased material and labor cost.

Handheld tape dispensers and applicators have been in widespread use for many years for relatively light-duty applications. For instance, prior tape dispensers and tape applicators have been used for dispensing adhesive tapes such as masking tapes, packaging tapes, cosmetic tapes, surgical tapes, and electrical tapes, etc. Tape dispensers and applicators have been used to dispense selected lengths of adhesive materials in strip form from a roll of tape. In many instances, the dispensers are used to dispense a single-sided adhesive tape having pressure-sensitive adhesive applied to only one face thereof, which tapes usually can be unreeled from a supply roll and directly applied to a surface without the need for elaborate dispensing devices. However, the use of lined adhesive tapes is desirable in many applications. Prior tape dispensing devices have been described for dispensing a strip of pressure-sensitive adhesive tape supported on a release liner. These tape dispenser devices have included configurations having a take-up spool for collecting release liner, which is driven by the unwinding of tape from a supply spool (e.g., see U.S. Pat. Nos. 3,969,181; 4,570,868; and 4,718,971).

Tape dispensing devices are generally known having smooth-surfaced pressure rollers for applying adhesive tape to a work surface. U.S. Pat. No. 4,460,433 indicates that uniform pressure throughout the width of an application pressure roller is needed for providing a good seal between a tacky web and a surface. U.S. Pat. No. 4,255,218 discloses a device for applying a portion of a strip of adhesive releasably carried on a liner to one surface of a member, which includes a firm platen having a radiused edge surface where the strip of adhesive is transferred. U.S. Pat. No. 4,980,011 discloses an automated liner removing transfer tape applicator including an application head supported for pressing the adhesive transfer tape onto a product. The application head is disclosed as a hard roller, soft roller, or “shoe” such as described in U.S. Pat. No. 4,255,218, applying and maintaining sufficiently high pressure to assure reliable transfer of adhesive from the tape to the product. The required application pressure is described as being 240 psi for most Scotch® brand adhesive transfer tapes. U.S. Pat. No. 5,342,466 discloses a device for applying a strip of sealant from a roll to a surface comprising a shaft and an applicator roller possessing a smooth cylindrical periphery. U.S. Pat. No. 6,382,291 discloses a dispenser for self-adhesive tape that includes a textured wheel, which is used to get traction on the application surface and simultaneously separate the backer from the adhesive layer, but it is not used as the application roller U.S. Pat. No. 3,753,839 discloses a non-uniform “pinch” roller having a reduced surface area to minimize contact with the adhesive layer, but it is not used press transfer adhesive tape to a surface. U.S. Pat. No. 6,431,242 discloses a self-adhesive item dispenser including an over-molded roller which interfaces with ribs to pull a release liner from the self-adhesive items.

Adequate pressure is required to create a seal with pressure-sensitive tape. Where handheld tape applicator devices are used, the pressure needed to create a seal is a force supplied by the user or installer. Tapes requiring high application pressures are burdensome and tiring, especially in more rigorous work environments such on those involving seam applications for inclined roof construction or wall construction using ladders, since they require a high user-applied application force. Moreover, the relatively high application pressures commonly applied and required with conventional tape applicator devices does not necessarily result in water-tight seals.

The present investigators have recognized a need for improved pressure rollers for tape applicator devices suitable for application of adhesive sealing tapes in the construction of roofs, walls, or other building structures. As will become apparent from the descriptions that follow, the inventive device and methods of its use addresses these needs as well as providing other advantages and benefits.

### SUMMARY OF THE INVENTION

The present invention is directed to a patterned pressure roller for tape applicators useful for reducing the user-applied force required to seat pressure-sensitive tape, or seating a tape requiring high application pressure with the same amount of user-applied force.

In one embodiment, the pressure roller has an upraised pattern comprising upraised land areas which surround a plurality of isolated recessed areas which remain out of contact with a tape being applied with the pressure roller. The patterned pressure roller reduces the amount of user-applied force required to create a seal between an adhesive tape and a substrate surface to which the tape is applied by concentrating the application force in an upraised pattern. The upraised pattern provides reduced tape-contacting surface area at the outer periphery of a cylindrical roller, effective to keep relatively small applied forces provided through the tape applicator focused at points of contact made between the upraised pattern and an underlying tape liner or tape. Even though the overall tape contacting area of the pressure roller is discontinuous and reduced, the patterned pressure roller can provide a better seal between seam tape and a substrate, as measured by water-seepage, on textured surfaces than smooth pressure rollers using similar or even more application pressure.

In one particular embodiment, the recessed portions have geometric shapes selected from the group consisting of diamonds, circles, triangles, squares, hexagons, stripes, etc., and more particularly may comprise diamond shapes. In another particular embodiment, the upraised pattern comprises upraised portions forming a continuous network extending across an entire lateral width of the applicator roller. The network particularly may comprise a regular repeating pattern encircling the periphery of the applicator roller. It has been observed that even though contact user-applied force made with a tape during transfer is limited to the upraised pattern portions of the pressure roller, that the adhesive coating or adhesive content of the adhesive tape thereafter tends to flow sufficiently to provide essentially continuous contact between a side of the tape and the substrate surface. In this manner, the tape gripping force can build with time after tape application using the patterned pressure roller. In one embodiment, only about 1 to about 10 pounds user-applied force, particularly about 2 to about 6 pounds user-applied force, and more particularly about 2 to about 5 pound user-applied force, need be applied to the tape applicator device equipped with a patterned pressure roller of embodiments of the present invention to attach an adhesive tape to a substrate. This compares favorably with prior tape applicator systems requiring 20 or more pounds force for tape securement.

In addition, by isolating the recessed portions of the pattern with upraised portions on the pressure roller, the network forms barriers to water movement across the pattern. Substrate texture may also be an important consideration. In one embodiment, elements of the upraised roller pattern are angled relative to any directionality presented by the surface texture of the substrate. In one particular embodiment, the upraised portions of the roller pattern have a leading edge inclined at an intersecting angle relative to a texture presented by the substrate surface. This creates an improved seal against water intrusion. The upraised roller pattern also provides good tape seals on relatively smooth, non-textured substrate surfaces.

In one embodiment, the total surface area of the upraised portions and the total area of the recessed portions is provided in a ratio of about 5:1 to about 1:10, respectively. The amount of contact area versus void area is an important factor in selection of the pattern for the pressure roller. The contact area determines the user-applied force needed to create the seal. This ratio can be varied by changing the line width and line spacing of the upraised pattern or network on the surface of the pressure roller.

In one embodiment, the applicator roller has a Durometer hardness index value of about 20 to about 70, particularly about 25 to about 50. The Durometer of the material used to form the outer portions of the pressure roller is an important consideration. The choice of Durometer selected for a tape applying application is impacted by the type of surface to which the tape is being applied and the type of tape. How to optimize these factors for various applications will become obvious from the description of the preferred embodiments. In one embodiment, the pressure roller comprises two concentric portions including an inner, harder Durometer, generally cylindrical core portion and an outer, softer Durometer, patterned surface portion. The above-indicated Durometer range values apply to the patterned surface portion. The outer patterned portion may be formed on the core in a number of manners, such via casting techniques, or by wrapping and attaching a pre-formed flexible patterned strip around the circumference of the core portion.

The patterned pressure rollers of embodiments of the present invention are generally adaptable for use on tape applicator devices, including handheld devices and mechanized devices, for applying pressure-sensitive adhesive tapes to surfaces. Tape applicators fitted with a patterned pressure roller according to embodiments herein can be used to apply lined or unlined pressure-sensitive adhesive tapes to surfaces.

In one embodiment, the patterned pressure roller of embodiments of the present invention may be used in adhesive tape applying devices designed for relatively heavy-duty applications such as building construction. For instance, the patterned pressure roller may be installed in tape applicator devices suitable for use in the construction of building structures, especially where it is desirable or useful to cover and seal gaps between abutting roofing panels, abutting wall panels, a window installation in a wall frame, a door installation in a wall frame, a plumbing vent installation in a roof, a skylight installation in a roof, a dormer in a roof, and so forth, with a moisture-resistant seam tape.

In one embodiment, there is a method of installing roofs using water-resistant panels arranged in an abutting configuration, wherein a tape applicator device is equipped with a patterned pressure roller according to embodiments of the present invention. The resulting applicator device is used to apply a water-resistant transfer adhesive seam tape to cover and seal the gaps between the abutting panels, followed by attaching an outer roofing coverage (e.g., shingles, shakes, slate, and metal, etc.) without the need to include the typical prior step of applying felt paper. In another embodiment, there is a method of installing walls using water-resistant panels arranged in an abutting configuration, wherein a tape applicator device is equipped with a patterned pressure roller of embodiments of the present invention and is used to apply a water-resistant transfer adhesive seam tape to cover and seal the gaps between the abutting panels, followed by completing the wall construction (e.g., adding siding, etc.) without the need to include the typical prior step of applying a water-proofing house wrap.

### BRIEF DESCRIPTION OF THE DRAWINGS

FIG. 1 is a perspective view of a device having a patterned pressure roller for applying adhesive tape to a building structure or other substrate, including a partial cut-away view of a tape cutting and tape spool core retainer thereof, according to an embodiment of the invention.

FIG. 2 is an enlarged bottom view of the forward position area of the tape applicator device of FIG. 1 showing the patterned pressure roller in greater detail.

FIGS. 3A, 3B, 4 and 5 are front elevational views of surface-patterned molded belt strips for use in patterned pressure rollers according to embodiments of the present invention.

FIG. 6 is a side elevational view of the device of FIG. 1 with a roll of tape mounted on the supply spool showing travel paths of a transfer adhesive tape material and an adhesive layer and a liner thereof during tape application on a substrate surface.

FIG. 7 is an exploded perspective view of the device according to FIG. 1.

FIG. 8 is a side elevational view of the device of FIG. 1 with a take-up spindle body removed and without a roll of tape mounted on the supply spool to show a gear train feature of the device.

FIG. 9 is an enlarged cross-sectional view of the supply spool and take-up spindle of the device of FIG. 1 including respective clutch means incorporated therein.

FIG. 10 is a perspective view including a partial cut-way view of the outer roofing coverage to show an underlying assembly of roofing structural panels having a moisture-resistant seam tape applied to gaps at abutting side edges thereof which has been applied with a device according to FIG. 1.

FIG. 11 is a perspective view including a partial cut-way view of the outer wall coverage to show an assembly of wall structural panels behind thereof having a moisture-resistant seam tape applied to gaps at abutting side edges thereof which has been applied with a device according to FIG. 1.

The figures and elements therein are not necessarily drawn to scale. Similarly numbered elements in different figures represent like features unless indicated otherwise.

### DETAILED DESCRIPTION OF THE PREFERRED EMBODIMENTS

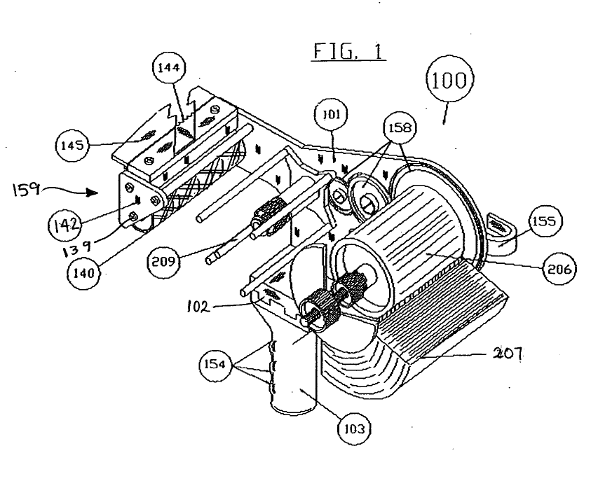

Preferred embodiments of the invention are described below by referring to the drawings. Referring to FIG. 1, a tape applicator 100 including a patterned pressure roller 140, also referred to herein as an applicator roller, is shown. A tape roll 207 is mounted on a supply spool 206. A take-up spindle 209, connected via gearing 158 to the supply spool 206, strips and stores release liner as a tape is dispensed. The device 100 has a pistol-style primary handle 103 attached to a support frame 101 of the device via a handle plate 102. The pressure roller 140 rotates on an axle 139 mounted between support plate 142 and support frame 101.

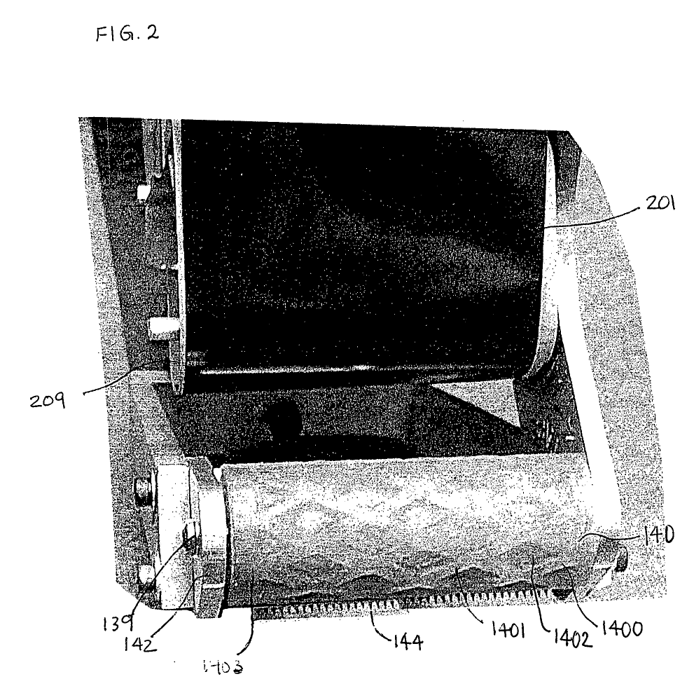

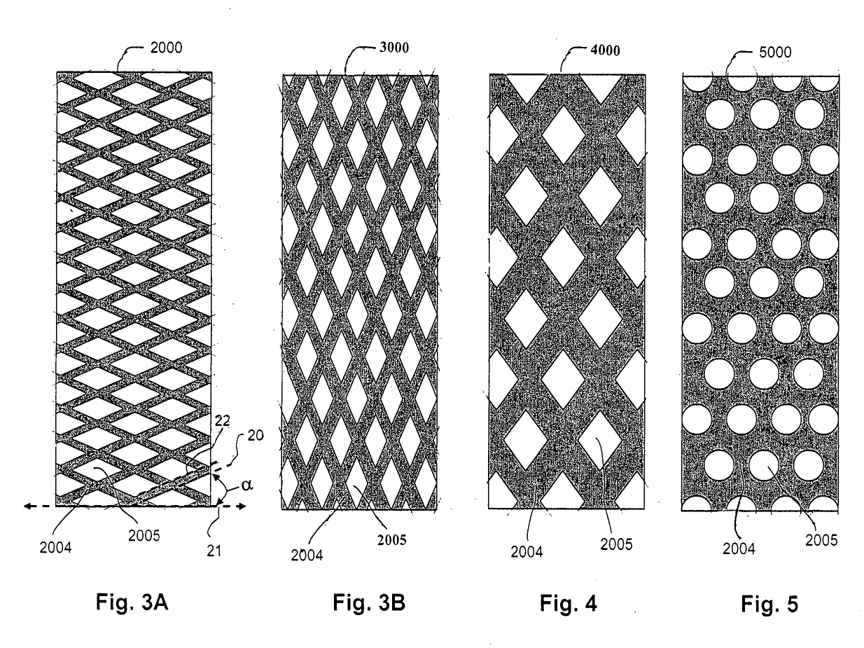

FIG. 2 shows an exemplary, non-limiting surface pattern comprising a network 1400 of upraised portions 1401 defining diamond shaped recesses 1402 around the outer cylindrical periphery 1403 of the pressure or applicator roller 140. FIGS. 3A, 3B, 4 and 5 show several additional non-limiting surface patterns 2000, 3000, 4000, and 5000, respectively, that could be used on the surface of the pressure roller 140, where upraised portions 2004 are indicated by the gray regions and the recessed portions 2005 are indicated by white spaces. One preferred embodiment of the surface pattern is a network or lattice of diamond shapes such as shown in FIGS. 3A and 3B. The pattern shown in FIG. 4 is similar to FIG. 3A except having wider lines, increased line spacing, and increased line angles. Other patterns include circles (FIG. 5), etc.

The pressure roller 140 has an upraised pattern comprising upraised land areas which surround a plurality of isolated recessed areas which remain out of contact with a tape being applied with the pressure roller. The recessed portions have geometric shapes selected from the group consisting of diamond, circle, triangle, square, hexagon, stripes, etc., and more particularly may comprise diamond shapes. In another particular embodiment, the upraised pattern comprises upraised portions forming a continuous network extending across an entire lateral width of the applicator roller. The network particularly may comprise a regular repeating pattern encircling the periphery of the applicator roller.

The patterned pressure roller reduces the amount of pressure required to create a seal between an adhesive tape and a substrate surface to which the tape is applied by concentrating the application force in an upraised pattern. The upraised pattern provides reduced tape-contacting surface area at the outer periphery of a cylindrical roller, effective to keep relatively small user-applied forces focused at points of contact made between the upraised pattern and an underlying tape liner or tape. Even though the overall tape contacting area of the pressure roller is discontinuous and reduced, the patterned pressure roller can provide a better seal between seam tape and a substrate, as measured by water-seepage, on textured surfaces than smooth pressure rollers using similar or even more application pressure. It also has been observed that even though contact user-applied force made with a tape during transfer is limited to the upraised pattern portions of the pressure roller, that the adhesive coating or adhesive content of the adhesive tape thereafter tends to flow sufficiently to provide essentially continuous contact between a side of the tape and the substrate surface. In this manner, the tape gripping force can build with time after tape application using the patterned pressure roller.

In one embodiment, only about 1 to about 10 pounds user-applied force, particularly about 2 to about 6 pounds user-applied force, and more particularly about 2 to about 5 pound user-applied force, need be applied to the tape applicator device equipped with a patterned pressure roller of embodiments of the present invention to attach an adhesive tape to a substrate. This compares favorably with prior tape applicator systems requiring 20 or more pounds force for tape securement. It will be understood by those skilled in the art that the amount of user-applied force required to seat a pressure-sensitive tape will depend on the tape as well. Therefore, the patterned pressure roller described reduces the amount of user-applied force needed to seat the tape relative to the amount needed to seat the same tape with a typical smooth pressure roller commonly found on existing tape applicators.

In addition, by isolating the recessed portions of the pattern with upraised portions on the pressure roller, the network forms barriers to water movement across the pattern. The network does not provide structural pathways for water to move through the network after tape application, helping to create a water resistant seal that prevents bulk water from entering the interior space during initial phases of construction. Substrate texture may also be an important consideration. In one embodiment, elements of the upraised roller pattern are angled relative to any directionality presented by the surface texture of the substrate. In one particular embodiment, the upraised portions of the roller pattern have a leading edge inclined at an intersecting angle relative to a texture presented by the substrate surface. This creates an improved seal against water intrusion.

In one embodiment, the total surface area of the upraised portions and the total area of the recessed portions is provided in a ratio of about 5:1 to about 1:10, and particularly about 3:1 to about 1:8 respectively. This ratio can be varied by changing the line width and line spacing of the upraised pattern or network on the surface of the pressure roller. The amount of contact area versus void area is an important factor in selection of the pattern for the pressure roller. The contact area determines the force needed to create the seal. For instance, if a smooth roller has 10 lbs. force applied on it and the roller has two square inch of surface area, then the applied pressure is 5 lbs/square inch. If, instead, the effective surface area of the roller is halved, such as by using an upraised surface pattern according to embodiments herein, then the total surface area of the roller would be reduced 50% to one square inch. If 10 lbs. of force is applied to that reduced surface area, then the panel will experience 10 lbs./square inch where the roller makes contact with the panel. Thus, application forces exerted on the tape are concentrated using the patterned pressure rollers of embodiments described herein.

In one embodiment, the applicator roll 140 (e.g., see FIGS. 1-2) of the applicator device 100 is comprised at least at its surface portions of a relatively hard yet resilient material having a Durometer hardness of between about 20 to about 70, particularly between about 25 and about 50. For a more textured substrate surface, the Durometer hardness of the applicator roll may be selected as a lower value than for a smoother substrate surface. A device applicator roller having the indicated hardness has sufficient flexibility and resiliency to allow an adhesive tape to better accommodate the topography of a substrate, especially uneven or textured surfaces. The adhesive tape can be applied in a manner making a water-resistant seal on uneven surfaces, such as gaps between structural components, with one pass or more of the applicator device. For example, the pressure applicator roller has a relatively low Durometer hardness but is sufficiently deformable in order to press a tape into crevices that are present on uneven surfaces, such as panels made of oriented strand board. The applicator roller also is firm enough to maintain enough nip pressure on the adhesive tape to provide secure bonding contact between the strip of adhesive tape and a substrate surface. The balance of resiliency and hardness provided in the pressure roller is important for providing a tight seal with a seam tape delivered by the applicator device onto a gap present between adjacent structural components, even if other structural features may be present in the tape delivery path which also introduce surface unevenness, i.e., roofing nails, metal joints, flashing, and so forth. For purposes herein, “Durometer hardness” refers to Shore A hardness unless indicated otherwise. The Shore hardness is measured using the ASTM test method designated ASTM D2240 00. The Durometer hardness values obtained from this test method are a useful measure of relative resistance to indentation of various grades of polymers.

In one embodiment, the pressure roller comprises two concentric portions including an inner, harder Durometer, generally cylindrical core portion and an outer, softer Durometer, patterned surface portion. The outer patterned portion may be formed on the core in a number of manners, such via casting techniques, or by wrapping and attaching (e.g., adhering) a pre-formed flexible patterned strip around the circumference of the core portion.

In one particular embodiment, patterned pressure rollers are made of polyurethane elastomeric with cores produced from castable urethane. Pressure rollers may be manufactured to have patterned surface portions having about 25 to about 50 Durometer. Modified nylon or other similar polymeric materials could also be used as a roller material. Other potentially useful materials for making the pressure rollers include synthetic and natural butyl rubber, and other elastomeric materials with a Durometer in the useful range.

The patterned pressure rollers may be manufactured by carving a full size model or master in wax or other material, then creating a form. Alternatively, a lathe could be used to impart a relief pattern in surface of the model. The form material is flowable and hardenable (e.g., hard rubber) or sinterable (e.g., ceramic) material that is filled in around the surface of the master and then solidified to form a negative of the pressure roller and the described surface pattern formed by the master. The form is a material selected to have a higher melting temperature than the wax master, such that the master can be removed by melting away the wax, and leaving the form. For example, a cylindrical pressure roller core of castable urethane or similar material, is placed at a geometrically centered location inside the form. In one non-limiting embodiment, the pressure roller core is about 3.5 to about 4.5 inch in length and about 0.375 to about 0.625 inch in diameter. Then the gap present between the inside surface of the form and the outer surface of the hard roller core is filled with an elastomeric castable polymeric molding compound selected to have a desired Durometer value upon setting, and the molding compound is allowed to set. A suitable molding compound may comprise, e.g., urethanes, such as those available from Rotokinetics (Athens, Ga.) and other commercial suppliers. The form needs to be a different material than the surface material of the pressure roller, and generally also needs to be flexible/stretchable to facilitate removal from a finished roller. The form material may be polymeric materials having these attributes, such as hard natural or synthetic rubber, silicone, etc. If a polymeric form is used, a vacuum is broken between the mold and the finished roller, and the composite urethane roller can be pushed out of the form and is ready for use. For purposes of larger scale production of the pressure roller, conventional injection molding techniques can be adapted to make the component.

Referring to FIG. 3A, the surface pattern 2000 provided on the applicator roller may have pattern angle α (alpha), which is measured between a leading edge 20 of a shape defining-upraised line or ridge and a horizontal line 21 that laterally traverses the peripheral cylindrical surface of the pressure roller and is parallel to the rotational axis of the pressure roller as indicated by hatched trace lines included in the figure. The angles α (alpha) may vary between 15 and 75 degrees. The trailing edge 22 of each upraised line generally extends parallel to the leading edge 20. For purposes herein, “vertical” refers to a direction along the circumference of the pressure roller, and “horizontal” means parallel to the rotational axis of the pressure roller. Referring to FIG. 3B, the diamond shapes shown in FIG. 3A have been rotated 90 degrees in pattern 3000. It will be appreciated that recess shapes with an aspect ratio other than one (diamonds, ovals, rectangles, etc.) may be used on the surface of the pressure roller oriented with their long (major) axis parallel or perpendicular to the axis of rotation without altering the basic function of the invention. A specific embodiment of one preferred pressure roller has an approximately 30 Durometer polyurethane elastomeric surface with a castable urethane core with a diamond pattern. In one non-limiting embodiment, the pattern may have an average line width of about 0.13 to about 0.18 inch with diamonds having about 43 to about 47 degree angle (absolute value) at a density of about 2.5 to about 3.5 diamonds/inch vertical and about 1 to about 3 diamonds/inch horizontal.

Another embodiment of a preferred pressure roller has an approximately 30 Durometer polyurethane elastomeric surface with a castable urethane core with a diamond pattern. The pattern may have an average line width of about 0.07 to about 0.08 inch with diamonds having about 20 to about 25 degree angle at a density of about 2 to about 3 diamonds/inch vertical and about 0.75 to about 1.25 diamond/inch horizontal.

Yet another embodiment of a preferred pressure roller has an approximately 30 Durometer polyurethane elastomeric surface with a castable urethane core with a diamond pattern. The pattern may have an average line width of about 0.07 to about 0.08 inch with diamonds having about 20 to about 25 degrees angles at a density of about 3 to about 4 diamonds/inch vertical and about 1 to about 2 diamonds/inch horizontal. This embodiment is designed to be used with an application pressure of about 12.75 lbs. versus a tape manufacturer's recommendation of 20 lbs of application pressure.

Another embodiment of a preferred pressure roller has an approximately 40 Durometer polyurethane elastomeric surface with a castable urethane core with a diamond pattern. The pattern may have an average line width of about 0.125 to about 0.135 inch with diamonds having about 40 to about 50 degree angles at a density of about 1.6 to about 1.7 diamonds/inch vertical and about 1.4 to about 1.6 diamonds/inch horizontal. This embodiment is designed to be used with an application pressure of 12.75 pounds (lbs.) versus the tape manufacturer's recommendation of 20 lbs. of application pressure.

Although not limited thereto, the patterned pressure rollers of the present invention may be mounted and used on a hand-grippable adhesive tape applicator, such as device 100 shown in FIG. 1, which is suitable for single-handed operation in building construction and other environments. The illustrated device 100 includes, e.g., a tape spool 206 and a take-up spindle 209 and a drive means 158 operable between them. An applicator 140 is provided at a forward position 159 of the device 100, and a tape cutting member and pivotal cutting member guard 145 are provided above the applicator roll 140. Although a take-up spindle 209 is illustrated, other type of rotary take-up means, including those commonly used in tape applicator devices, also could be used, such as a take-up roller, reel, or spool. Building construction work, for example, is often carried out under less than ideal weather conditions such as high and low temperatures, high humidity, etc. All of these factors tend to introduce moisture to the hand and makes gripping difficult.

As illustrated in FIG. 1, the handle or hand grip 103 of tape applicator device 100 has a profile which varies along its length to accommodate to the palm of the user. The central portion of the handle should fit into the hollow of the user's palm. The handle may be more bulbous in the central portion of the handle.

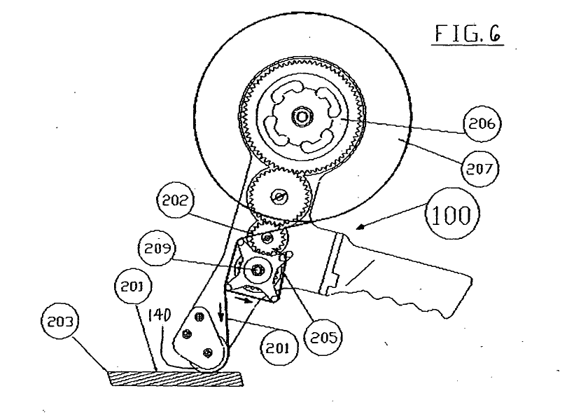

As illustrated in FIG. 6, the device 100 is operable in manner that allows an adhesive layer 201 of a transfer adhesive material 202 to be transferred onto a substrate surface 203 while a protective release liner 205, which separates successive wound layers of adhesive layer on the wound supply roll of tape 207 mounted on tape spool 206, is collected around take-up spindle 209. The tape 207 generally may be a conventional configuration with a strip of adhesive material successively wrapped around a hollow circular core adapted to be releasably fitted upon tape spool 206. The device 100 also may be used apply non-backed single-sided adhesive tape material to a substrate, wherein there is no need use take-up spindle 209 to collect spent liner. As adhesive tape is applied and stuck to surface 203 as applicator device 100 is pulled across the surface 203, tension is created in transfer adhesive tape 202 creating a torque force on supply spool 206, causing it to rotate and unreel more tape. Rotation of tape spool 206, in turn, causes rotation of take-up spindle 209 so that it can simultaneously and automatically collect more spent liner via a drive means which is described in greater detail below. The effective outer diameters of the supply tape spool 206 and the take-up spindle 209 are constantly changing since the adhesive tape 202 is unwound from a tape roll 207 mounted for rotation on tape spool 206 and the spent release liner 205 is collected on the take-up spindle 209. For instance, in a tape applying operation such as for building construction, the effective diameter at the tape spool 206 is relatively large initially and progressively decreases as supply tape is paid out during tape application using device 100 while the spent liner wraps around and accumulates on the tape spindle 209 such that its effective diameter progressively increases. The ideal mechanical drive ratio needed between the tape spool 206 and take-up spindle 209 thus generally will vary as the effective sizes of the rolls on the spool and spindle varies during a tape dispensing operation using applicator device 100.

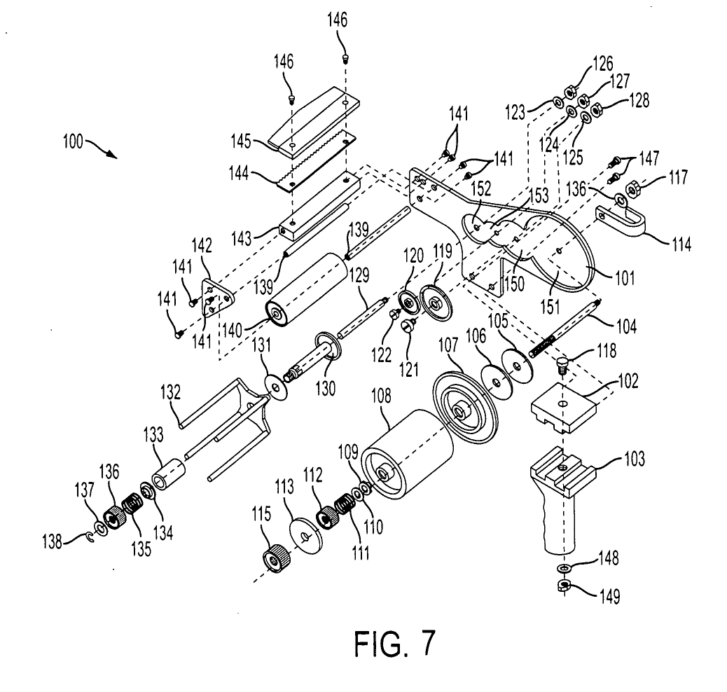

Referring to FIG. 7, an exemplary illustration of device 100 is shown with various elements and components thereof including the following: 101: Side frame; 102: Handle Plate; 103: Handle; 104: Tape spool shaft; 105: Felt friction disk; 106: Steel friction plate; 107: Tape spool gear; 108: Tape core mandrel; 109: Engagement washer; 110: Anti-slip washer; 111: Tape spool tension spring; 112: Tape spool tension knob; 113: Tape spool core retainer; 114: Tape spool anti-slip washer; 115: Tape spool retainer knob; 116: Lock washer; 117: Tape spool shaft nut; 118: Handle bolt; 119: Large idler gear; 120: Small idler gear; 121: Large idler gear hub shaft; 122: Small idler gear hub shaft; 123: Take-up spindle flat washer; 124: Small idler gear shaft flat washer; 125: Larger idler gear shaft flat washer; 126: Take-up spindle shaft nut; 127: Small idler gear shaft nut; 128: Larger idler gear shaft nut; 129: Take-up spindle shaft; 130: Take-up spindle gear; 131: Take-up spindle friction plate; 132: Take-up spindle body; 133: Take-up spindle spacer; 134: Take-up spindle hub washer; 135: Take-up spindle tension spring; 136: Take-up spindle tension adjustment knob; 137: Take-up spindle keeper washer; 138: Take-up spindle retaining clip; 139: Steel shaft; 140: patterned pressure or applicator roller; 141: Machine screw; 142: Support plate; 143: Knife block; 144: Serrated Cutter or Knife; 145: Knife guard; 146: Bolts; 147: Bolts; 148: Washer; 149: Nut; 150: frame recess for idler gear 119; 151: frame recess for drive gear 107; 152: frame recess for take-up spindle gear 130; 153: frame recess for idler gear 120; 154: ribbing; and 155: hook.

It will be understood that the elements and their manners of assembly in device 100 as illustrated in FIG. 7 are exemplary and non-limiting. Some of the illustrated components, such as fasteners and washers, etc., have some practical significance but are not themselves critical to the invention and are included merely to further clarify the illustration.

Still referring to FIG. 7, the side frame 101 is unitary and relatively rigid part. Frame 101 may be, for example, a cast or stamped metal part, or a shaped or molded composite material or ceramic material, etc. For instance, the device 100 may be a cast aluminum or steel frame plate, used together with plastic rollers, tape wells, and gears. As also can be seen in FIG. 7, the integral circular recesses 150 to 153 provided for rotatably mounting the respective drive gears within the side frame 101 are axially aligned with respect to their centers, and open into each other at their axial (lateral) sides such that the gears can be intermeshed at those locations while still being retained within the respective frame recesses. The hand grip 103 mounted to a base portion 102 of the frame 101 is operable to allow the device 101 to be held by a single hand of an operator. In one embodiment, the hand grip 103 is attached to the base portion 102 of the frame 101 at a position such that the center of gravity of the device 101 with a mounted tape roll is over the center of an operator's wrist. For instance, as indicated by the view of FIG. 1, the base portion 102 stands off the side frame 101 (i.e., towards the viewer in this perspective) at a generally perpendicular angle and supports the hand grip 103 directly underneath. Even if a relatively wide tape roll is mounted on tape spool 206, the center of gravity of the device 100 generally still remains over the center of gravity of an operator's wrist, providing enhanced ergonomics and ease of operation.

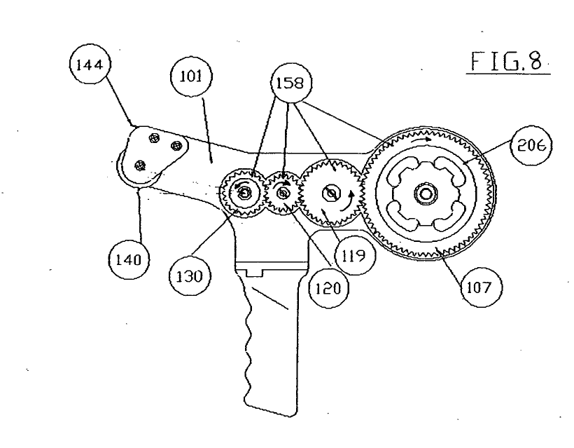

Referring to FIG. 8, the gears 107, 119, 120 and 130 are illustrated in this example as comprising gear wheels having gear teeth extending around their circumferences. The gears are rotatably seated in their respective recesses provided the side frame 101 such that gear teeth of adjacent gears intermesh. As shown by the indicated directional arrows, rotation of the supply spool 206 causes rotation of its associated drive gear 107 which in turn rotates the take-up spindle gear 130 through the drive means 158. The two intervening idler gears 119 and 120 transmit the rotational force of the tape spool drive gear 107 to the take-up spindle gear 130. Although not required, the provision of an even number of idler gears (e.g., 2, 4, 6, etc.) allows the rotational direction of the supply spool 206 to be reversed as transmitted through the gear train to the take-up spindle 209 so that it can automatically wind-up liner as the supply spool unreels fresh tape. The idler gears also help provide clearance on the frame between the supply spool and the take-up spindle. The drive means 158 provided in device 100 allows the angular rotational speed of the release liner take-up spindle 209 to be automatically synchronized with angular rotation speed of said tape spool 206. The drive gear 107 is larger than the driven gear 130 providing a mechanical transmission ratio such that the take-up spindle is rotated at an angular speed as fast as, and preferably faster than, that of the supply spool 206, so that occurrence of slack in the tape is reduced or prevented. Consequently, the adhesive tape and release liner remain taut and generally slack-free, but are not stretched to the point of rupture, as they are respectively unwound and/or rewound by applicator device 100.

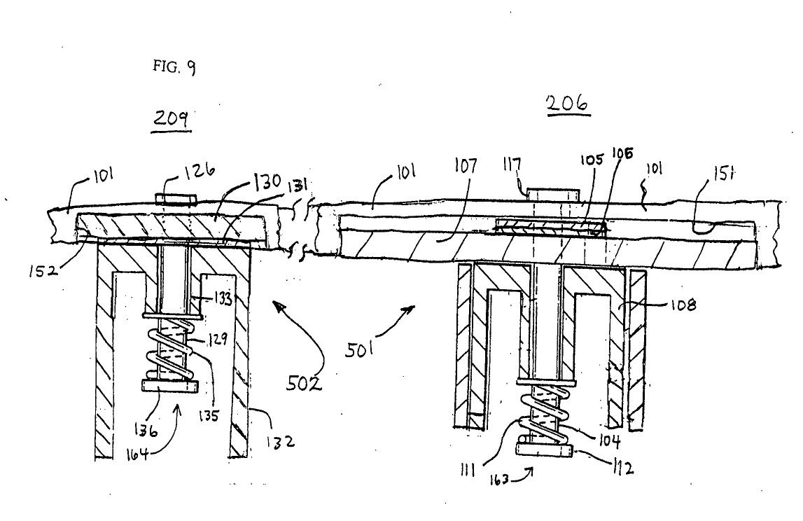

Referring to FIG. 9, a first clutch means 501 is shown that is included in the tape spool 206 operable to restrict the rotational speed thereof. A second clutch means 502 is shown that is included in the take-up spindle 209 operable to restrict the rotational speed thereof and allow slip. As indicated, the effective outer diameters of the supply tape spool 206 and the take-up spindle 209 constantly change as the adhesive tape 202 is unwound from a tape roll 207 mounted for rotation on tape spool 206 and the spent release liner 205 is collected on the take-up spindle 209. In general, the tape spool gear 107 is sized larger in diameter than the spindle gear 130 sufficient to provide a mechanical drive ratio between the tape spool 206 and take-up spindle 209 which will ensure that the take-up spindle 209 is rotated at an angular speed which is the same or greater than that of the tape spool 206 for all effective diameters of tape rolls and wound spent liner on device 100 during a tape application run or runs using a given tape roll. In this manner, the adhesive tape and liner are kept taut and generally slack-free, but are not over-tensioned or over-tightened.

Still referring to FIG. 9, clutch means 501 includes a felt friction plate 105 and an adjacent steel friction plate 106 urged into contact with tape spool gear 107 via spring biasing means 163 comprising helical spring 111 arranged on the tape spool shaft 104 rigidly attached to the backside of the frame 101 via lock washer 117. The spring 111 is held in compression against the tape core mandrel 108 via tension adjustment knob 112, which in turn urges the gear 107 against friction plate 106. The first clutch 501 is operable to dissipate excess speed of rotation of the tape spool to reduce or prevent overstretching of the tape, and it also reduces or prevents self-tightening and tape spool slippage. Clutch means 502 includes a friction plate 131 urged into contact with take-up spindle gear 107 via spring biasing means 164 comprising helical spring 135 arranged on the spindle shaft 129 rigidly attached to the backside of the frame 101 via lock washer 126. The spring 135 is held in compression against the take-up spindle spacer 133 of the spindle body 132 via tension adjustment knob 136, which in turn urges the friction plate 131 against gear 130, which effectively restricts the rotational speed of the gear but also allows for slip. The second clutch means 502 in the take-up spindle allows the take-up spindle to slip so that it can move at the same angular speed as the tape spool while also being operable to dissipate excess speed of rotation of the take-up spindle to reduce or prevent overstretching of the liner and/or slippage of the take-up spindle in a rotational direction opposite to the wind-up direction which might lead to slack in the spent liner during tape application.

It will be appreciated that the patterned pressure roller illustrated herein also can be implemented in other tape applicator systems, particularly those which offer an axle or rod for rotatably mounting the patterned pressure roller and means for feeding adhesive tape at least partially around the pressure roller sufficient for transfer pressure to be applied thereto, such as in lieu of a smooth-surfaced applicator roller mounted on such an axle or rod of the tape applicator.

The handheld tape applicator 100 can handle a wide variety of tape widths, depending on the application, including but not limited to relatively large tape widths, such as up to about 8 inches or even more, depending on the scale of the assembled device and weight of the tape roll carried thereon. The applicator device 100 of embodiments herein similarly can accommodate a relatively large diameter roll of adhesive tape having a large strip length, which reduces the frequency of tape roll changes needed.

Before initiating a tape application operation with device 100, a roll of adhesive tape 207 is mounted on the tape spool 206 of device 100 (e.g., see FIG. 1). The adhesive tape may be a transfer adhesive tape material comprising an adhesive layer or film (e.g., a moisture-resistant single-sided pressure-sensitive adhesive film) carried on a releasable backing or liner. In one embodiment, the release liner may have a thickness of about 4 mils, and the release backing and adhesive layer have a target thickness of about 12 mils. Optionally, the tape may have a backing of a thickness of about 1.0 mils to about 15 mils and an adhesive layer disposed on the backing of a thickness of about 2.0 mils to about 30.0 mils. The dry coefficient of friction for the tape is preferably at least about 0.6. Alternatively, the device 100 may be used to apply non-backed single-sided adhesive tapes. The device 100 is adapted to store, handle and apply relatively hefty spools of adhesive tapes. These adhesive tapes include, for example, a roll of transfer adhesive tape material wound on a core part thereof which is mounted on the supply spool, wherein the tape adhesive material has a width of 2 to 8 inches and has a diameter of 3 to 10 inches, and an initial roll weight of up to about 20 pounds, particularly about 2 to about 10 pounds.

In one embodiment, to provide linear speed parity for the initial circumference of an about 7 to about 8 inch diameter tape roll mounted at the supply spool 206 and an initial spent liner circumference on the take-up spindle 209 having a diameter of about 2.5 to about 3.0 inch, the device 100 incorporates a gear train 158 providing an initial mechanical ratio of about 2.5 to about 3.5 between the tape spool 206 and take-up spindle 209.

To operate the tape applicator 100, an operator loads the tape onto the tape core mandrel with the tape unwinding in the clockwise direction. Then the release liner is fed into the take-up spool using the nip rollers for securing the tape; using the nip rollers, tighten the release liner around the take-up spool. To operate, the operator simply places the tape in the desired location and pulls the applicator towards himself/herself while applying pressure to the pressure applicator roller to “seat” the tape. Once the tape is installed, the operator can cut the tape using the serrated knife located above the pressure applicator roller. This operation is repeated until all of the seams are covered.

In this general manner, the handheld applicator device 100 may be used in such a manner to apply strips of moisture-resistant seam tape to seal gaps or crevices associated with a building structure, such as abutting roofing panels, abutting wall panels, a window installation in a wall frame, a door installation in a wall frame, a plumbing vent installation in a roof, a skylight installation in a roof, and a dormer in a roof. The applicator device 100 makes it possible to apply seam, ridge and valley tape in building constructions applications with a handheld device instead of installing the tape by hand. This speeds up the construction process and avoids unwound release paper collecting around the work surface. For valley applications, an operator can run a strip of tape on one side of the seam where ⅓ to ¼ of the tape overlaps the seam. Then another strip is run on the other side of the seam with the same amount of tape overlapping. In this manner, the two pieces of tape comprise a “tape seam” of about 6″ in width with tape sealing on panel and tape sealing on tape at the overlapping areas.

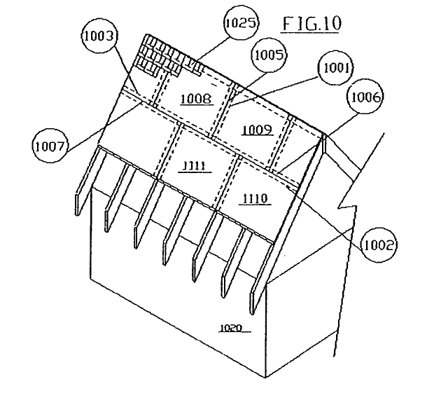

Referring to FIG. 10, the handheld applicator device 100 may be used to apply strips of moisture-resistant seam tape 1001, 1002, 1003, etc. (indicated by parallel hatched lines) to cover gaps 1005, 1006, 1007, etc., between adjacent structural panels 1008, 1009, 1010, 1011, etc., applied to a roof surface or frame 1020 before outer roofing coverage 1025 (e.g., shingles, shakes, slate, and metal) is applied thereover. The adjacent structural panels may have an integral water-resistant layer or coating on one or both major faces thereof. The seam tape protects the abutting edges of the adjacent panels. This method of applying seam tape with device 100 eliminates the need for the installation of felt paper or tar paper for roof construction.

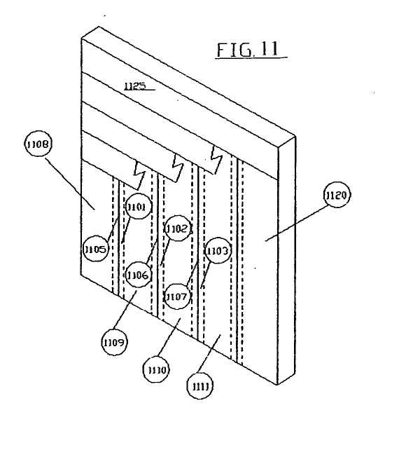

Referring to FIG. 11, the handheld applicator device 100 also may be used to apply strips of moisture-resistant seam tape 1101, 1102, 1103, etc. (indicated by parallel hatched lines) to cover gaps 1105, 1106, 1107, etc., between adjacent structural panels 1108, 1109, 1110, 1111, etc., applied to a wall surface or frame 1120 before outer wall coverage 1125 (e.g., siding) is applied thereover. The adjacent structural panels may have an integral water-resistant layer or coating on one or both major faces thereof. The seam tape again protects the abutting edges of the adjacent panels. This method of applying seam tape with device 100 eliminates the need for installing additional water impermeable membrane or other wall wraps for wall construction. The applicator 100 may also be used, for example, for the application of window flashing tape up to four inches in width with an outside diameter no greater than 7.75 inches.

In one preferred embodiment, a tape applicator equipped with the patterned pressure roller according to embodiments herein is used to apply tape over the seams of abutting sheathing panels on a roof or wall. The sheathing panels have an overlay of resin-impregnated Kraft paper and a texture have been embossed into the surface of the overlaid sheathing panel. The texture has a pattern that generally runs in two directions; one along the length of the panel and the second along the width of the panel.

The roll of adhesive tape used needs to be wide enough to cover and seal the seams or gaps formed between abutting panels in such building construction applications, but not too wide to hinder application. It generally may be about 2 inches or wider, but typically not wider than 36 inches, with 2 to 8 inches being a preferred range for many applications. For wider tapes, a “push” application method may be better than a pull application method. Two examples of water-resistant seam tape which may be used are PROGRIP 6038 tape made by 3M, St. Paul Minn., and B14 tape made by Tyco International.

The Examples that follow are intended to illustrate, and not limit, the invention. All percentages described herein are by weight, unless indicated otherwise.

### EXAMPLE

### Example 1

Water penetration tests were performed on panels seamed panels using a tape applicator equipped with one of several different patterned pressure rollers representative of embodiments of the present invention and several control rollers in the following manner. The tape applicator device was of the type described in FIGS. 1, 6-8 herein. In this testing, the tape was applied at ambient temperatures of approximately 80-90° F. Each specimen roller pattern was tested twice with the same tape.

Test protocol used: 1) Cut 2 inch×4 inch studs and nailed them together to form a 24 inch×24 inch frame including a central stud. 2) Cut one panel of an OSB substrate to dimensions of 12 inch×24 inch, laid it on top of the frame with the panel edges oriented perpendicular to and overlying the central stud, and nailed the panel to the surface of the frame. One half of the frame was covered with panel, and the other half was still exposed at this juncture. 3) Cut two panels of OSB substrate to 12 inch×12 inch sizes, and each 12 inch by 12 inch panel was nailed on top of the exposed side of the frame such that inner edge of the 24 inch×24 inch panel and the inner edges of the 12 inch×12 inch panels had a ⅛ inch gap provided between them, and the two 12 inch×12 inch also had a ⅛ inch gap between their adjoining edges along the central stud. 4) A first (short) tape was applied along the short seam between the 12 inch×12 inch panels using applicator which covered that seam and continued for a short distance on to the adjoining 24 inch×24 inch panel. Enough pressure was used to seat the tape well onto the surface of the panels in one pass. It was ensured that the tape extended 1 inch past the longer seam but no more than 1.5 inch. 5) Then, a second (longer) tape strip was applied along the long seam using the tape applicator. Used pressure equivalent to that that would be applied during normal installation (i.e., about 8 pounds force).

Installation of Bucket to Test Specimen: 1) Cut off bottom 4 inches of a 5-gallon bucket. 2) Applied silicone caulking (i.e., Silicone II) to the top of the 5-gallon bucket. 3) Turned over bucket and carefully applied caulked end to the test specimen surface, centering the bucket over the T-seam. Applied light pressure to seal. 4) Caulking was allowed to dry for two days.

Testing of Test Specimen: 1) With test specimen at test temperature, added enough room temperature water to give 2 inches of water head. 2) Observed for any leaking to occur below the sample after 15 minutes. 3) If no leaking occurs, increased the water to 4 inches. If leaking occurs, stopped the test. After 15 minutes, observed for any leaking. 4) If no leaking occurs, repeated with 8 inches of water and then 12 inches of water. 5) Recorded at what water height leaking occurred. The time period until leaking occurred (i.e., minutes to leakage) was recorded for each water height used in the test runs.

Patterned Test Rollers: As patterned test rollers, the following rollers were tested. A “plastic” test roller had a series of 5 mm thick upraised stripes provided in parallel with about 2.8 mm recessed spacing from one another, where the stripes extended peripherally along the circumference of the roller. The plastic roller was manufactured by taking a round hard plastic roller and machining 2.8 mm grooves, spaced 5 mm apart, into the surface of the roller. The plastic roller diameter was 3.8 cm (1.5 inches). A “metal” test roller had an upraised pattern of squares having 4 mm long sides. The metal roller was made by taking a cylindrical aluminum rod, drilling a hole through the middle of it for the steel shaft (139) to pass through it. Next, 4.6 mm wide and 2.5 mm deep grooves were machined into the face every 4.4 mm parallel to the axis. The remaining raised areas were then machined with a 3.6 mm wide and 4.9 mm long groove running perpendicular to the axis. These grooves were spaced 3.7 mm apart. The metal roller diameter was 3.6 cm (1.4 inch). A “green belt” pattern was a green-colored molded polyvinylchloride (PVC) belting strip manufactured by taking conveyor belting, wrapping it around a wooden core and gluing the belting to the core. The pattern of the green belt roller was comprised of rows of undulating peaks and valleys that are parallel to the roller axis. The subsequent row was comprised of undulating peaks and valleys with the peak slightly depressing in toward the core. The valleys of this row were smaller than the valleys of the previous row. That is, each succeeding row of peaks is offset from the previous. When looking at any large peak, the next large peak was moved over to the right slightly. The angle from vertical that this offset formed was approximately 5 degrees. The pattern undulated from left to right and then from right to left. This pattern was repeated around the circumference of the core. The large peak width (horizontal) was 0.15 inch, and large peak width (vertical) was 0.07 inch, and a horizontal spacing between peaks was 0.15 inch. The small peak width (horizontal) was 0.07 inch, and small peak width (vertical) was 0.08 inch, and a horizontal spacing between peaks was 0.21 inch. The green belt material had a thickness of 0.18 inch. The green belt roller diameter was 3.4 cm (1.4) inches in diameter. A “diamond” belt roller was manufactured by taking surface-patterned styrene-butadiene rubber conveyor belting (Durometer ˜70) and wrapping it around a wooden core and gluing the belting to the core. The diameter of the diamond roller was 1.4 inch with a line thickness of 0.8 mm (0.03 inch). The diamonds on the pattern were spaced at 2.5 diamond/inch horizontal and 0.875 diamonds/inch vertical to the rotational axis. The line angles of the diamonds were at 22.5 degrees relative to a horizontal direction that laterally traverses the peripheral cylindrical surface of the pressure roller and is parallel to the rotational axis of the pressure roller. A “Control” roller tested was a smooth surfaced urethane roller (35 Durometer) of about 3.8 cm (1.5 inch) diameter. A “Grooved Control” roller had slits going around the circumference of the roller, cut into a control roller. Each section ideally would compress independently to allow for variations in panel thickness. In Table 1, “½ hands” refers to 1 or 2 hands on the tape applicator to control application pressure.

TABLE 1

| | | | Inches of | Minutes to |
|---|---|---|---|---|
| 1/2 Hands | Roller Type | Durometer | water | Leakage |
| 1 | Plastic | 60 | 1 | 7 |
| 2 | Plastic | 60 | 2 | 20 |
| 1 | Metal | 60 | 1 | 20 |
| 2 | Metal | 60 | 2 | 15 |
| 1 | Green Belt | 30 | 1 | 7 |
| 2 | Green Belt | 30 | 2 | 20 |
| 1 | Diamond | 30 | 2 | 30 |
| 2 | Diamond | 30 | 4 | 60 |
| 1 | Control | 35 | 1 | 12 |
| 2 | Control | 35 | 2 | 20 |
| 1 | Grooved | 35 | 1 | 15 |
| | Control | | | |
| 2 | Grooved | 35 | 4 | 60 |
| | Control | | | |

The tape applicator fitted with a grooved pressure roller was used to seal the seams between abutting sheathing panels. The grooves were cut along the radius of the pressure roller, and the sheathing panels had a texture that generally ran in two directions; one along the length of the panel and the second along the width of the panel. Thus, the roller's pattern was nearly parallel to that on the sheathing panel's surface in one direction. This pressure roller did not produce an adequate water-tight seal.

### Example 2

A tape applicator was used to apply commercial Zip™ tape over the seams of abutting sheathing panels on a roof. The sheathing panels had an overlay of resin-impregnated Kraft paper and a texture had been embossed into the surface of the overlaid sheathing panel. The texture had a pattern that generally runs in two directions; one along the length of the panel and the second along the width of the panel. The tape applicator was of the type described in FIGS. 1, 6-8 herein and was equipped with a patterned pressure roller (1.5 inch diameter) having diamond shapes cut into its outer peripheral surface generally according to FIG. 2 (average upraised line width of about 0.138 inch; 45 degree angle; 3 diamonds/inch vertical; 2.5 diamonds/inch horizontal; 30 Durometer).

An excellent water tight seal was provided that was able to pass, with a single pass of the pressure roller over the tape at an application pressure of 4.25 pound force, the ASTM E331-00 “Standard Test Method for Water Penetration of Exterior Windows, Skylights, Doors, and Curtain Walls by Uniform Static Air Pressure Difference” at 2.86 PSF, 6.24 PSF and 12.00 PSF of negative pressure under water spray. A smooth pressure roller used in the otherwise identical tape applicator did not pass this test.

### Example 3

Another water penetration test was performed on seamed panels in compliance with the ASTM E331-00 Standard Test Method, albeit with a smaller test chamber than the one used in Example 2. The tape applicator device was the same as that described in Example 2.

Summary of Test Method: This test method consisted of sealing the test specimen into one face of a test chamber, exhausting air from the chamber at the rate required to maintain the test pressure difference across the specimen, while spraying water onto the outdoor face of the specimen at the required rate and observing any water penetration.

Apparatus: The description below of apparatus used is general in nature.

Test Chamber: A test chamber or box with an opening in which a removable mounting frame was installed with the specimen installed on the frame. One static pressure tap was provided to measure the chamber pressure. The back of the chamber consisted of a glass plate. The user sat under the glass plate to observe the testing: i.e., if any leakage occurs.

Air System: An exhaust system, controlled by air valve, was attached to the chamber to provide the air pressure difference across the specimen. The system provided essentially constant airflow at a fixed pressure for the required test period. The nozzles used in the spray system provided a flow rate that exceeds the required volume of 5.0 U.S. gal/ft²·h in the ASTM E331 standard. The water spray system had nozzles spaced on a uniform grid located at a uniform distance from the test specimen.

Test Specimen: The chamber could accommodate a sample that was approximately 4 foot wide by 8 foot long or smaller. Various configurations of samples could be used.

Test Pressure: Tests were conducted at 2.86 lbf/ft² vacuum. The water pump used exceeded the ASTM E331 test method requirement for water flow. Failure was defined as any visible water penetration at a taped seam.

Test Procedure: Panel samples were nailed to the frame. In this case, approximately 6 inch wide samples were nailed to the frame and the tape applicator was used to apply the tape to the seams between two OSB panel samples. Two seams were taped at the same application pressure with application pressures of 4.25 lbs, 5.75 lbs, 8.5 lbs and 9.75 lbs. Application pressure was achieved by placing weights on the weight peg at the front of the applicator. The applicator was then pulled from the rear hand grip, down the track. That ensures that a consistent application pressure was applied across the tape and the track, eliminating wrinkles caused by unintentional side to side movement during application of the tape. Next the frame was placed into the chamber. The gaps between the sample frame and the testing chamber were sealed with Zip™ tape to ensure that water infiltration did not occur around the edges of the frame. This tape was pressure rolled into place with a J Roller as much as possible. Next the spray frame was installed above the sample surface and connected to a pump. The pump sat in a water reservoir. Vacuum was initiated on the chamber and once the desired pressure was achieved, then the water spray was initiated. An observer sat under the plexiglass bottom, to detect any leaks, for 15 minutes or until all samples failed.

A patterned pressure roller was used that was a diamond patterned polyurethane roller of 35 Durometer hardness. The diameter of the roller was 1.44 inch with a line thickness of 0.17 inches. The diamonds on the pattern were spaced at 1 diamond/inch horizontal and 3 diamonds/inch vertical to the rotational axis. The line angles of the diamonds were at 22.5 degrees relative to a horizontal direction that laterally traverses the peripheral cylindrical surface of the pressure roller and is parallel to the rotational axis of the pressure roller.

TABLE 2

| | |
|---|---|
| Roller | 35 Durometer |
| | Diamond Pattern roller |
| Vacuum | 1.86 lb/ft square |

| Application | |
|---|---|
| Pressures | Results |
| 4.25 | passed (no leaks) |
| 4.25 | passed (no leaks) |
| 5.75 | passed (no leaks) |
| 5.75 | slight infrequent leaks |
| 8.5 | slight and infrequent leaks |
| 8.5 | slight but frequent leaks |
| 9.75 | slight and infrequent leaks |
| 9.75 | slight but frequent leaks |

While the invention has been particularly described with specific reference to particular process and product embodiments, it will be appreciated that various alterations, modifications and adaptations may be based on the present disclosure, and are intended to be within the spirit and scope of the present invention as defined by the following claims.

1. A device for applying an adhesive tape material to a substrate, comprising:
a frame;
an applicator roller having an outer surface comprising an upraised pattern, said roller rotatably mounted to said frame, adapted to press transfer adhesive tape material comprising an adhesive layer, optionally carried on a release liner, against a substrate;
a tape spool rotatably mounted to said frame, adapted to i) support a roll of the adhesive material, and ii) unreel adhesive tape material to the applicator roll as the applicator roll moves against a substrate with the adhesive layer in contact therewith;
optionally a release liner take-up means rotatably mounted to said frame, adapted to take-up release liner, if present, after separation from the adhesive layer of the adhesive tape material.

2. The device of claim 1, wherein the upraised pattern comprises upraised portions which surround a plurality of isolated recessed portions.

3. The device of claim 2, wherein the recessed portions have geometric shapes selected from the group consisting of diamond, circle, triangle, square, and hexagon.

4. The device of claim 2, wherein the recessed portions have diamond shapes.

5. The device of claim 1, wherein the upraised pattern comprises upraised portions forming a continuous network extending across an entire width of the applicator roller.

6. The device of claim 2, wherein the total surface area of the upraised portions and the total area of the recessed portions is provided in a ratio of about 5:1 to about 1:10, respectively.

7. The device of claim 1, wherein the applicator roller has a Durometer hardness index value of about 25 to about 70.

8. The device of claim 1, wherein the applicator roller has a Durometer hardness index value of about 30 to about 50.

9. The device of claim 1, wherein the device further includes a roll of adhesive tape material mounted on the supply spool, wherein the adhesive tape material has a width of 2 to 8 inches and has a diameter of 3 to 10 inches, and an initial roll weight of about 2 to about 10 pounds.

10. The device of claim 9, wherein the adhesive tape material comprises an adhesive layer comprising a moisture-resistant single-sided pressure-sensitive adhesive film carried by a liner.

11. The device of claim 1, further comprising a hand grip mounted to a base portion of said frame.

12. The device of claim 1, further comprising drive means drivingly connecting the tape spool and release liner take-up spindle.

13. A tape applicator roller for use in a tape applicator adapted to press transfer adhesive tape material against a substrate, said roller comprising an outer surface comprising an upraised pattern.

14. The tape applicator roller of claim 13, wherein the upraised pattern comprises upraised portions which surround a plurality of isolated recessed portions.

15. The tape applicator roller of claim 13, wherein the recessed portions have geometric shapes selected from the group consisting of diamond, circle, triangle, square, and hexagon.

16. The tape applicator roller of claim 14, wherein the recessed portions have diamond shapes.

17. The tape applicator roller of claim 13, wherein the upraised pattern comprises upraised portions forming a continuous network extending across an entire width of the applicator roller.

18. The tape applicator roller of claim 14, wherein the total surface area of the upraised portions and the total area of the recessed portions is provided in a ratio of about 5:1 to about 1:10, respectively.

19. The tape applicator roller of claim 13, wherein the applicator roller has a Durometer hardness index value of about 25 to about 70.

20. The tape applicator roller of claim 13, wherein the applicator roller has a Durometer hardness index value of about 30 to about 50.

21. The tape applicator roller of claim 13, wherein the applicator roller comprises two concentric portions including an inner, harder Durometer, generally cylindrical core portion and an outer, softer Durometer, patterned surface portion.

22. A method of constructing a building structure, comprising:
(A) providing a roofing or wall frame;
(B) fastening a plurality of structural panels having an integral moisture barrier in an abutting arrangement onto the frame with fastening means;
(C) covering a gap formed between the abutting structural panels with a water-resistant seam tape using a tape applicator device, wherein the tape applicator device comprises:
a frame,
an applicator roller having an outer surface comprising an upraised pattern, said applicator roller rotatably mounted to said frame, adapted to press transfer adhesive tape material comprising an adhesive layer, optionally carried on a release liner, against a building structure,
a tape spool rotatably mounted to said frame, adapted to i) support a roll of the adhesive tape material, and ii) unreel adhesive tape material to the applicator roll as the applicator roll moves against a building structure with the adhesive layer in contact therewith,
an optional release liner take-up means rotatably mounted to said frame, adapted to take-up release liner, if present, after separation from the adhesive layer of the adhesive tape material,
(D) applying an outer roofing or wall coverage on at least a portion of the abutting structural panels, without applying a felt layer before applying the outer roofing or wall coverage.

23. The method of claim 22, wherein the upraised pattern comprises upraised portion comprising a leading edge inclined relative to directionality in a textured surface of the building structure receiving the adhesive tape material.

24. The method of claim 22, comprising applying about 1 to about 10 pounds user-applied force to the tape applicator device to attach the adhesive tape material to the building structure.

25. The method of claim 22, comprising applying about 2 to about 6 pounds user-applied force to the tape applicator device to attach the adhesive tape material to the building structure.

26. A method for sealing gaps or crevices associated with a building structure selected from the group consisting of abutting roofing panels, abutting wall panels, a window installation in a wall frame, a door installation in a wall frame, a plumbing vent installation in a roof, a skylight installation in a roof, and a dormer in a roof; by applying a seam tape to cover the gap or crevice using the device of claim 1.
